(19) United States
(12) Patent Application Publication
(10) Pub. No.: US 2010/0120308 A1
(43) Pub. Date: May 13, 2010

(54) OXO-BIODEGRADABLE NETTING

(75) Inventor: Guangda Shi, Woodbury, MN (US)

Correspondence Address: BROOKS KUSHMAN P.C., 1000 TOWN CENTER, TWENTY-SECOND FLOOR, SOUTHFIELD, MI, 48075, US

(73) Assignee: CONWED PLASTICS LLC, Minneapolis, MN (US)

(21) Appl. No.: 12/617,145

(22) Filed: Nov. 12, 2009

Related U.S. Application Data
(60) Provisional application No. 61/114,218, filed on Nov. 13, 2008.

(51) Int. Cl. D03D 9/00; B29C 47/04; D04B 1/14

(52) U.S. Cl. 442/1; 264/171.1; 66/202

(57) ABSTRACT

The present invention provides a degradable extruded netting. The netting comprises a plurality of interconnected strands with at least some of the strands comprising a degradable composition comprising a polyolefin and a metal carboxylate. The present invention also relates to a method for making degradable extruded netting. The method comprises extruding strands of polymeric material to form a netting wherein at least some of the strands are formed of the degradable composition.

### CROSS-REFERENCE TO RELATED APPLICATIONS

This application claims the benefit of U.S. provisional application Ser. No. 61/114,218 filed Nov. 13, 2008

### BACKGROUND OF THE INVENTION

1. Field of the Invention

The present invention relates to degradable netting, composites made with degradable netting, and methods for making the same.

2. Background Art

Plastic nets have found a number of uses in commerce. For example, these nets have found use as agricultural netting, such as turf netting, turf wrap, hay bail wrap, erosion control netting, packaging netting, food packaging netting, such as for onion and turkey bags, and netting for industrial, filtration and home furnishings applications.

Two chief types of plastic nets include knitted netting and extruded netting. Knitted netting is netting that has been formed via the knitting of plastic strands. The strands are typically formed via extrusion and slitting. Extruded netting is netting in which the strands are extruded from a die with the joints being formed either within the die or immediately outside the die. A variety of netting configurations are known, such as square, diamond, twill, etc.

Since netting materials often find their way into the environment, either through their implanting as a result of their intended use or as waste or debris, it has become desirable to provide netting which is degradable. A degradable plastic material is defined, according to ASTM D20-96, as plastic material that undergoes a significant change in its chemical structure under specific environmental conditions resulting in a loss of some properties that may vary as measured by standard test methods appropriate to the plastic and the application in a period of time that determines its classification. Degradation can take place by exposure to heat, microorganisms, moisture, oxidation, UV light, other chemical reactions, mechanical stress, and combinations thereof. Initially, plastic will degrade into smaller molecules as its components molecular weights decrease. This results in decreased mechanical properties of the plastic materials. Such decreases include lower tensile strength and increased brittleness. Degradation tends to result in the plastic material being broken up into smaller plastic particles that are hydrophilic and can be consumed by microorganisms. The subsequent biodegradation can be measured by ASTM D6954

In addition to being degradable, the netting must be capable of being made via the extrusion process for the composition to be considered versatile and thus more valuable.

Polyolefins have been found to be a suitable material for use in the extruded netting manufacturing process, as well as the knitted netting process. However, due to the sensitivities of the extrusion and orientation processes, such as those of the tentering or bi-axial orientation process, the use of even small amounts of seemingly acceptable additives to the polyolefin can render the resulting composition useless. For instance, certain color additive with a polyethylene carrier can have a negative processing on polypropylene netting. It will cause large thickness variations and netting splits during orientation.

Also, the polymer blend must be capable of being processed at relatively high temperatures, such as above 275° F. (125° C.), and above 400° F. (205° C.) in the case of some polyolefins, such as polypropylene. Problems that could occur if the material cannot withstand the processing temperatures include, premature degradation, gassing, void formation and color shift of material.

Furthermore, the rate of degradation of any netting must be slow enough that the netting does not degrade (either at all or too much) before it has fully served its purpose. As such, the material used to make the netting must be able to be extrudable to form netting or slit film having desired structural properties, such as flexibility, orientability, tensile strength and degradability, and be cost effective.

### SUMMARY OF THE INVENTION

The present invention provides a degradable extruded netting. The netting comprises a plurality of oriented interconnected extruded strands or knitted strands.

In one embodiment, at least some of the strands are made of a degradable composition consisting essentially of a polyolefin and an oxo-biodegradable additive. In at least one embodiment, the degradable composition consists essentially of 95 to 99.95 wt. % of a polyolefin and 0.05 to 5 wt. % of an oxo-biodegradable additive, based on the total weight of the degradable composition.

In another embodiment, at least some of the strands are made of a degradable composition consisting essentially of a polyolefin and a metal carboxylate.

In yet another embodiment, at least some of the strands are made of a degradable composition consisting essentially of a polyolefin, a metal carboxylate. and a stabilizer. Examples of certain stabilizers include, but are not necessarily limited to, heat stabilizer, UV/light stabilizer, oxidation stabilizer, radical scavengers, etc). In certain instances, the stabilizer can either be used to aid extrusion (so the formulation does not degrade while being processed or stabilize the formulation for a useful functional life in the actual application.

In at least one embodiment, the stabilizer comprises a sacrificial free radical scavenger. In another embodiment, the stabilizer further comprises a photosensitive free radical scavenger.

In other embodiments, at least some of the strands are made of a degradable composition consisting essentially of a polyolefin, a metal carboxylate, a stabilizer and a colorant.

In still other embodiments, at least some of the strands are made of a degradable composition consisting essentially of a polyolefin, a metal carboxylate, a stabilizer and conventional additives.

In other embodiments, the degradable composition consists essentially of a polyolefin, an oxo-biodegradable additive, and a stabilizer. In at least one embodiment, the degradable composition consists essentially of 93 to 99.94 wt. % of a polyolefin, 0.05 to 5 wt. % of an oxo-biodegradable additive, and 0.01 to 2 wt. % of a stabilizer, based on the total weight of the degradable composition.

In yet other embodiments, the degradable composition consists essentially of a polyolefin, an oxo-biodegradable additive, and a photo-degradable additive. In at least one embodiment, the degradable composition consists essentially of 90 to 99.90 wt. % of a polyolefin, 0.05 to 5 wt. % of an oxo-biodegradable additive, and 0.05 to 5 wt. % of a photo-degradable additive, based on the total weight of the degradable composition.

In still yet other embodiments, the degradable composition consists essentially of a polyolefin, an oxo-biodegradable additive, a photo-degradable additive, and a stabilizer. In at least one embodiment, the degradable composition consists essentially of 88 to 99.89 wt. % of a polyolefin, 0.05 to 5 wt. % of an oxo-biodegradable additive, 0.01 to 2 wt. % of an stabilizer, and 0.05 to 5 wt. % of a photo degradable additive, based on the total weight of the degradable composition.

In still yet even other embodiments, the degradable composition consists essentially of a polyolefin, an oxo-biodegradable additive, a photo-degradable additive, a stabilizer, and conventional additives/colorant. In at least one embodiment, the degradable composition consists essentially of 78 to 99.79 wt. % of a polyolefin, 0.05 to 5 wt. % of an oxo-biodegradable additive, 0.01 to 2 wt. % of a stabilizer, 0.05 to 5 wt. % of a photo degradable additive, and 0.1 to 10 wt. % conventional additives/colorant, based on the total weight of the degradable composition.

Any suitable oxo-biodegradable additive can be used. A suitable oxo-biodegradable additive is an additive that causes the degradation of plastic materials based primarily on exposure to heat. While metal carboxylates are relatively well known oxo-biodegradable additives, examples of other oxo-biodegradable additives include, but are not limited to, unsaturated organic compound which are auto-oxidizable like ethers, acetals, ketals, amines, aldehydes, natural oils, unsaturated fatty acids and other compounds that help in the generation of free radicals and peroxides that are involved in the oxidation reactions.

Any suitable photo-degradable additives can be used. A suitable photo-degradable additive is an additive that causes the degradation of plastic materials based primarily on exposure to light. Examples of photo-degradable additives include, but are not limited to, photo sensitive polymers like aromatic ketones, aromatic amines, peroxides, quinones, and azo compounds.

Any suitable polyolefin can be used. In at least one embodiment, suitable polyolefins have a number average molecular weight (Mn) of 20,000 to 100,000, a weight average molecular weight (Mw) of 100,000 to 700,000, a PDI of 2 to 25, an MFR of 0.03 to 20 g/10 min., as measured in accordance with ASTM 1238, condition E or L, as appropriate, a flexural modulus of 350 to 350,000 psi as measured in accordance with ASTM D790, a tensile strength at yield of less than 6,501 psi as measured in accordance with ASTM D638, an elongation at break of 1 to 1,200% as measured in accordance with ASTM D638, a tensile strength at break of 200 to 8,000 psi as measured in accordance with ASTM D638, a hardness of 45 shore A to 110 Rockwell R as measured in accordance with ASTM D2240 (shore A); ASTM 785 (Rockwell R), a melting point of 30° C. to 180° C. as measured in DSC melting point at a rate of 10° C./min., and a density of 0.850 to 0.965 g/cm³ as measured in accordance with ASTM D792.

In at least one embodiment, the polyolefin is a polypropylene having an MFR of 0.1 to 20 g/10 min. as measured in accordance with ASTM 1238, condition L, a tensile modulus of 500 to 3,000 MPa as measured in accordance with ISO 527-2, a tensile strength at yield of 10-60 MPa as measured in accordance with ISO 527-2, an elongation at yield of 1 to 25% as measured in accordance with ISO 527-2, a flexural modulus of 500 to 3,000 MPa as measured in accordance with ISO 178, a Rockwell hardness (R-scale) of 75 to 125 as measured in accordance with ISO 2039-2, a melting point of 150° C. to 180° C. as measured in accordance with ISO 3146, and a density of 0.880 to 0.920 g/cm³ as measured in accordance with ISO 1183.

In at least another embodiment, the polypropylene comprises a homopolymer.

In at least one embodiment, the metal carboxylate comprises a transition metal stearate such as a stearate of iron, manganese, zinc or nickel etc.

Examples of certain usable stabilizers include, but are not necessarily limited to, aromatic amines, sterically hindered phenols, organophosphites, thioesters, etc.

Examples of other usable stabilizers include, but are not necessarily limited to, stabilizers to protect the netting from excessive degradation if exposed to UV light. In at least certain embodiments, the stabilizer comprises a hindered amine such as an oligomeric hindered amine light stabilizer (HALS). As such, other examples of usable stabilizers include multifunctional antioxidant or blends of stabilizers such as phenols mixed with trivalent phosphorous hydroperoxide decomposers or triosynergists. Such mixtures can exhibit a synergistic effect. Other scavenger like carbon centered radical scavengers, such as lactones and acrylated bis-phenols, can be effective in oxygen deficient environments.

The present invention also relates to a method for making degradable extruded and knitted nettings. In one embodiment, the method comprises extruding strands of degradable polymeric material to form a netting. In another embodiment, the method comprises knitting extruding strands of degradable polymeric material to form a netting.

### BRIEF DESCRIPTION OF THE DRAWINGS

FIG. 1 is perspective view of the netting of the present invention.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The FIGURE is not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for the claims and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of”, and ratio values are by weight and based on solids; the term “polymer” includes “oligomer”, “copolymer”, “terpolymer”, and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; and the first definition of an acronym or other abbreviation applies to all subsequent uses herein of the same abbreviation and applies mutatis mutandis to normal grammatical variations of the initially defined abbreviation.

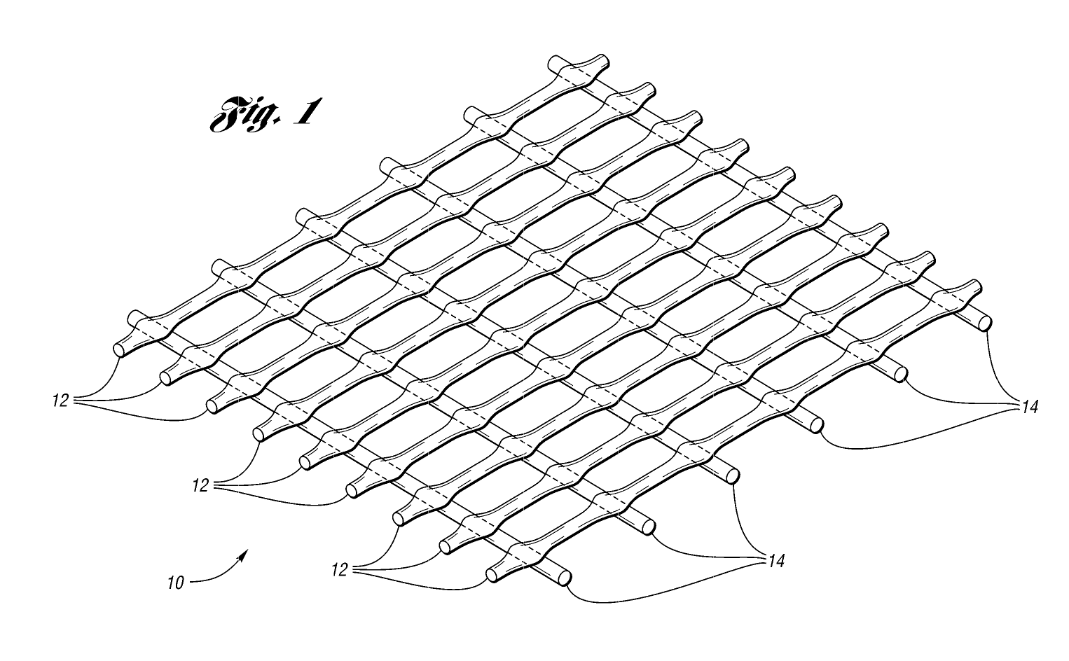

The present invention provides a netting 10, an exemplary one of which is shown in FIG. 1. The netting comprises strands 12 extending in one direction and strands 14 extending in a generally crosswise or transverse direction. The strands 12 and 14 are extruded polymeric elongate members which cross and intersect during extrusion to form the net-like structure. The strands 12 and 14 could also be formed of extruded strands that are knitted together rather than crossing during extrusion. In at least one embodiment, the strands 12 and 14 are made of the same material.

In at least another embodiment, strands 12 are made of a different material than strands 14. In this embodiment, the netting may comprise 10 to 90 wt. % of the material comprising strands 12 and 10 to 90 wt. % of the material comprising strands 14. In other embodiments, the netting may comprise 45 to 55 wt. % of the material comprising strands 12 and 45 to 55 wt. % of the material comprising strands 14.

In embodiments where the strands 12 and 14 are made of the same material, the material comprising the strands 12 and 14 is a degradable composition. When a material other then the degradable composition is used to manufacture one of the sets of strands 12 or 14, such material may comprise a non-, or lesser, composition material. Any such suitable other material could be used such as elastomeric materials such as styrenic block copolymers, Hytrel®, and Santoprene® and polyurethane, polyester, olefin block copolymers, olefin segmented copolymers and polyamide thermoplastic elastomers. The other (i.e., non-degradable) material may also comprise non-elastomeric materials such as nylons, polyesters, polylactic acids, polypropylene, polyethylenes including HDPE and copolymers of such resins, with the polyolefins being preferred and with polypropylene being especially preferred.

In certain embodiments, the degradable composition consists essentially of a polyolefin and an oxo-biodegradable additive. In at least one embodiment, the degradable composition consists essentially of 95 to 99.95 wt. % of polyolefin and 0.05 to 5 wt. % of oxo-biodegradable additive, based on the total weight of the degradable composition.

In other embodiments, the degradable composition consists essentially of polyolefin, oxo-biodegradable additive, and a stabilizer. In at least one embodiment, the degradable composition consists essentially of 93 to 99.94 wt. % of polyolefin, 0.05 to 5 wt. % of oxo-biodegradable additive metal carboxylate and 0.01 to 2 wt. % of a stabilizer, based on the total weight of the degradable composition.

In still yet other embodiments, the degradable composition consists essentially of polyolefin, oxo-biodegradable additive, stabilizer and colorant. In at least yet another embodiment, the degradable composition consists essentially of 89 to 99.93 wt. % of polyolefin, 0.05 to 5 wt. % of oxo-biodegradable additive, 0.01 to 2 wt. % of stabilizer, and 0.01 to 4 wt. % of colorant, based on the total weight of the degradable composition.

In still yet additional other embodiments, the degradable composition consists essentially of polyolefin, metal carboxylate, stabilizer, colorant, and conventional additives. In at least still yet another embodiment, the degradable composition consists essentially of 79 to 99.83 wt. % of polyolefin, 0.05 to 5 wt. % of oxo-biodegradable additive, 0.01 to 2 wt. % of stabilizer, 0.01 to 4 wt. % of colorant, and 0.1 to 10 wt. % conventional additives, based on the total weight of the degradable composition.

In certain embodiments, the degradable composition comprises a polyolefin and an oxo-biodegradable additive. In at least one embodiment, the degradable composition comprises 95 to 99.95 wt. % of polyolefin and 0.05 to 5 wt. % of oxo-biodegradable additive, based on the total weight of the degradable composition.

In other embodiments, the degradable composition comprises polyolefin, oxo-biodegradable additive, and a stabilizer. In at least one embodiment, the degradable composition comprises 93 to 99.94 wt. % of polyolefin, 0.05 to 5 wt. % of oxo-biodegradable additive metal carboxylate and 0.01 to 2 wt. % of a stabilizer, based on the total weight of the degradable composition.

In still yet other embodiments, the degradable composition comprises polyolefin, oxo-biodegradable additive, stabilizer and colorant. In at least yet another embodiment, the degradable composition comprises 89 to 99.93 wt. % of polyolefin, 0.05 to 5 wt. % of oxo-biodegradable additive, 0.01 to 2 wt. % of stabilizer, and 0.01 to 4 wt. % of colorant, based on the total weight of the degradable composition.

In still yet additional other embodiments, the degradable composition comprises polyolefin, metal carboxylate, stabilizer, colorant, and conventional additives. In at least still yet another embodiment, the degradable composition comprises 79 to 99.83 wt. % of polyolefin, 0.05 to 5 wt. % of oxo-biodegradable additive, 0.01 to 2 wt. % of stabilizer, 0.01 to 4 wt. % of colorant, and 0.1 to 10 wt. % conventional additives, based on the total weight of the degradable composition.

In certain embodiments, the degradable composition consists of a polyolefin and an oxo-biodegradable additive. In at least one embodiment, the degradable composition consists of 95 to 99.95 wt. % of polyolefin and 0.05 to 5 wt. % of oxo-biodegradable additive, based on the total weight of the degradable composition.

In other embodiments, the degradable composition consists of polyolefin, oxo-biodegradable additive, and a stabilizer. In at least one embodiment, the degradable composition consists of 93 to 99.94 wt. % of polyolefin, 0.05 to 5 wt. % of oxo-biodegradable additive metal carboxylate and 0.01 to 2 wt. % of a stabilizer, based on the total weight of the degradable composition.

In still yet other embodiments, the degradable composition consists of polyolefin, oxo-biodegradable additive, stabilizer and colorant. In at least yet another embodiment, the degradable composition consists of 89 to 99.93 wt. % of polyolefin, 0.05 to 5 wt. % of oxo-biodegradable additive, 0.01 to 2 wt. % of stabilizer, and 0.01 to 4 wt. % of colorant, based on the total weight of the degradable composition.

In still yet additional other embodiments, the degradable composition consists of polyolefin, metal carboxylate, stabilizer, colorant, and conventional additives. In at least still yet another embodiment, the degradable composition consists of 79 to 99.83 wt. % of polyolefin, 0.05 to 5 wt. % of oxo-biodegradable additive, 0.01 to 2 wt. % of stabilizer, 0.01 to 4 wt. % of colorant, and 0.1 to 10 wt. % conventional additives, based on the total weight of the degradable composition.

In certain embodiments, biodegradation promoter (micronized cellulose) may be provided in an amount of 0.1 to 5 wt. %, based on the total weight of the degradable composition, to help promote biodegradation after the polymer has broken down to lower molecular weight.

In certain embodiments, the degradable composition comprises, in other embodiments consists essentially of, and in still yet other embodiments consists of, based on the total weight of the degradable composition:

| Components | Weight % | Weight % | Weight % |
|---|---|---|---|
| Polyolefin | 89% to 99.9% | 91% to 99.65% | 95% to 98% |
| Oxo- | 0.1% to 5% | 0.25% to 3% | 0.5% to 1.5% |
| biodegradable | | | |
| additive master | | | |
| batch | | | |
| (concentrate | | | |
| with a carrier) | | | |
| Colorant master | 0% to 4% | 0% to 4% | 1% to 2.5% |
| batch | | | |
| (concentrate | | | |
| with a carrier) | | | |
| Stabilizer master | 0% to 2.0% | 0.1% to 2.0% | 0.5% to 1.0% |
| batch | | | |
| (concentrate | | | |
| with a carrier) | | | |

Preferably, the degradable composition does not include any citric acid and can degrade in the presence or absence of UV light.

Any suitable polyolefin may be used. Conventionally, a polyolefin is a homopolymer or copolymer of α-olefins or of diolefins, such as, for example, ethylene, propylene, 1-butene, 1-octene and butadiene Particularly, suitable polyolefins include polypropylene, polyethylene, and mixtures thereof.

Suitable polypropylenes include, but not necessarily limited to Atofina Polypropylene PPH 3060 from Atofina S.A. of Brussels, Belgium and Basell Pro-fax PH229 from Basell USA Inc. of Maryland. In at least one embodiment, suitable polyolefin materials may have the following characteristics:

| Characteristic | Measurement Technique |
|---|---|
| Avg. Mn = 60,000-74,000 | GPC using PS standard |
| Avg. Mw-300,000-460,000 | GPC using PS standard |
| PDI = Mw/Mn = 6.4-7.5 | |
| Melt flow rate = 1.4-1.9 g/10 min. | ISO 1133 |
| Tensile Modulus = 1,400 MPa. | ISO527-2 |
| Tensile strength at yield = 35 MPa. | ISO 527-2 |
| Elongation at yield = 10%-11% | ISO 527-2 |
| Flexural Modulus = 1.300-1420 MPa. | ISO 178 |
| Rockwell Hardness (R-scale) = 90-93. | ISO 2039-2 |
| Melting Point = 165° C.-175° C. | ISO 3146 |
| Density = 0.90-0.905 g/cm². | ISO 1183 |

Polyethylene resins useful for the present invention, in at least one embodiment, include homopolymers of ethylene and copolymers of ethylene with other olefinic hydrocarbon monomers such as propylene, 1-butene, 1-hexene, 4-methylpentene-1 and diolefins (e.g., 1,3-butadiene, 1,4-hexadiene, 1,5-hexadiene). It should be understood that when polyethylene copolymers are present, the polyethylene copolymer resins will have ethylene as the major constituent. It should also be understood that as used herein, the term polyethylene refers to both homopolymers and copolymers of ethylene.

Any suitable oxo-biodegradable additive can be used. A suitable oxo-biodegradable additive is an additive that causes the degradation of plastic materials based primarily on exposure to heat. While metal carboxylates are relatively well known oxo-biodegradable additives, examples of other oxo-biodegradable additives include, but are not limited to, unsaturated organic compound which are auto-oxidizable like ethers, acetals, ketals, amins, aldehydes, natural oils, unsaturated fatty acids and other compounds that help in the generation of free radicals and peroxides that are involved in the oxidation reactions.

The preferred metal carboxylates are cobalt, cerium and iron stearate. Other suitable metal carboxylates are carboxylates containing aluminum, antimony, barium, bismuth, cadmium, chromium, copper, gallium, lanthanum, lead, lithium, magnesium, mercury, molybdenum, nickel, potassium, rare earths, silver, sodium, strontium, tin, tungsten, vanadium, yttrium, zinc or zirconium. In at least one embodiment, the metal carboxylate is present in the degradable composition in an amount greater than 0.01 wt. %.

In at least one embodiment, the stabilizer comprises a sacrificial free radical scavenger. In another embodiment, the energy absorber further comprises a photosensitive free radical scavenger.

Since the metal carboxylate and the stabilizer could have a propensity to absorb water, the components can be treated to prevent water absorption. For instance, they can be coated with a barrier such as glycerol monostearate, glycerol tristearate, or pentaerythritol tetrustearate. The metal carboxylate and the stabilizer can be blended with the polyolefin as separate components or as a combined component. In either case, i.e., as separate components or a combined component, the metal carboxylate and the stabilizer can be supplied to the polyolefin in a carrier. Such carriers are preferably low melting, low density polyolefins, and are more preferably polyethylene. Suitable carriers for the metal carboxylate and the stabilizer are disclosed in U.S. Pat. No. 5,854,304, which is hereby incorporated by reference. Furthermore, processes for employing the carboxylate and the stabilizer in carriers are set forth in U.S. Pat. No. 5,854,304.

In at least one relatively preferred embodiment, the metal carboxylate and the stabilizer are supplied as a single component. Suitable examples of single components containing these materials are Reverte™ (grades BD92845, BD92771, & BD93470), available from Wells Plastic Limited of Staffordshire, United Kingdom. Also d₂w 93324, d₂w 93283 from Symphony Environmental of Hertfordshire United Kingdom.

In at least one embodiment, colorant is provided. One suitable colorant includes the green colorant 29025 GN PE Masterbatch, available from PolyOne Corporation of Assesse, Belgium, which is a green colorant in a carrier to impart green color to the resulting extruded netting

In at least one embodiment, colorant is added in an amount of 0.001 to 4 wt. % (solids), in other embodiments from 0.1 to 3.5 wt. %, and in yet other embodiment from 1 to 2.5 wt. %, based on the total weight of the degradable composition. Colorants are capable of affecting the degradation rate since it can diminish the intensity of the UV rays, by reflect, diffuse, absorb, or defract the UV rays.

The stabilizer can help to protect the netting from excessive degradation from exposure to UV light. In at least certain embodiments, the stabilizer comprises a hindered amine compound, such as an oligomeric hindered amine light stabilizer or HALS. In this embodiment, the amine compound is present in the degradable composition in an amount of less than 2.5 wt. %, and in other embodiments from 0.01 to 1.0 wt. %, and in yet other embodiments from 0.05 to 0.3 wt. %, based on the total weight of the degradable composition. In at least one relatively preferred embodiment, the hindered amine stabilizer comprises Tinuvin® 783, available from Ciba.

In another embodiment, the rate of degradation can be controlled by controlling the amount of titanium dioxide, or other suitable colorant, in the degradable composition such that in addition to heat degradation, UV degradation can occur at a desired level depending upon the amount of colorant in the degradable composition.

Suitable conventional additives include processing aids, fillers, such as talc, antioxidants already in the polymer from suppliers, slip, and antiblock.

The degradable composition can be made by any conventional process for forming these types of compositions. These processes include, but are not necessarily limited to, compounding. Generally, suitable methods for making the composition comprise compounding, either as a separate operation using a twin-screw extruder (preferred method in at least one embodiment), or in-line compounding using a single-screw extruder equipped with a screw that features good distributive and dispersive mixing characteristics.

In at least one embodiment, the degradable composition has a number average molecular weight (Mn) of between 20,000 and 100,000. In other embodiments, the number average molecular weight is between 40,000 and 80,000, and in yet other embodiments between 60,000 and 65,000. The measurement of number average molecular weight is preferably accomplished by GPC using polystyrene standards as described, for example, in U.S. Pat. No. 5,338,822.

In at least one embodiment, the degradable composition has a weight average molecular weight (Mw) of between 100,000 and 700,000. In other embodiments, the weight average molecular weight is between 300,000 and 550,000, and in yet other embodiments between 400,000 and 460,000. The measurement of weight average molecular weight is preferably accomplished by GPC using polystyrene standards as described, for example, in U.S. Pat. No. 5,338,822.

When the polyolefin is polypropylene, the polydispersity index (PDI) of the degradable composition is generally a function of branching or cross linking and is a measure of the breadth of the molecular weight distribution. In certain embodiments the PDI (Mw/Mn) of the degradable composition is between 2 and 25, in other embodiments between 3 and 20, and in yet other embodiments between 6 and 9. Of course, increased bridging or cross linking may increase the PDI.

In at least one embodiment, the melt flow rate (MFR) of the degradable composition can be measured using standard ASTM No. 1238, condition L testing procedures. In certain embodiments the degradable composition has a MFR between 0.1 and 20 g/10 min., in other embodiments, between 0.5 and 10 g/10 min., and in yet other embodiments between 1.25 and 5 g/10 min.

In at least one embodiment, the degradable composition has a tensile modulus of between 500 and 3,000 MPa. In other embodiments, the tensile modulus is between 750 and 2,000 MPa, and in yet other embodiments between 1,000 and 1,500 MPa. The measurement of tensile modulus is preferably accomplished by a tensile test in accordance with ISO 527-2.

In at least one embodiment, the degradable composition has a tensile strength at yield of between 10 and 60 MPa. In other embodiments, the tensile strength is between 15 and 50 MPa, and in yet other embodiments between 30 and 40 MPa. The measurement of tensile strength at yield is preferably accomplished by ISO 527-2.

In at least one embodiment, the degradable composition has an elongation at yield of 1 to 25%. In other embodiments, the elongation at yield is between 2.5 to 17.5%, and in yet other embodiments between 7.5 and 12.5%. The measurement of elongation at yield is preferably accomplished by ISO 527-2.

In at least one embodiment, the degradable composition has a flexural modulus of between 500 to 3,000 MPa. In other embodiments, the flexural modulus is between 750 and 2,000 MPa, and in yet other embodiments between 1,000 and 1,500 MPa. The measurement of flexural modulus is preferably accomplished by ISO 178.

In at least one embodiment, the degradable composition has a Rockwell hardness (R-scale) of between 75 to 125. In other embodiments, the Rockwell hardness is between 80 to 105, and in yet other embodiments between 85 and 95. The measurement of Rockwell hardness is preferably accomplished by ISO 2039-2.

In at least one embodiment, the degradable composition has a melting point of 150° C. to 180° C. In other embodiments, the melting point is between 155° C. and 175° C., and in yet other embodiments, between 160° C. and 170° C. The measurement of melting point is preferably accomplished by ISO 3146.

In at least one embodiment, the degradable composition has a density of between 0.850 to 1.20 g/cm³. In other embodiments, the density is between 0.89 to 1.00 g/cm³, and in yet other embodiments between 0.90 to 0.95 g/cm³. The measurement of density is preferably accomplished by ISO 1183.

The extruded strands can be made by any suitable extrusion process and extruded netting can be made by any conventional netting extrusion process.

Generally, suitable methods for making the extruded netting comprises extruding the degradable composition through dies with reciprocating or rotating parts to form the netting configuration. This creates cross machine direction strands that cross the machine direction strands, which flow continuously. Of course, it should be understood that the degradable composition could be used to form both the cross machine direction strands and the machine direction strands, or one or part of the strands, in which case, another material such as another degradable composition or a non-degradable material could be used to form the other strands. After the extrusion, the netting is then typically stretched in the machine direction using a differential between two sets of nip rollers. After this, the material is then typically stretched in any suitable manner, such as that described in U.S. Pat. No. 4,152,479, which is incorporated herein by reference, in the cross direction using a tenter frame. It should be understood, that the above described method is just one of many suitable methods that can be employed to manufacture extruded netting in accordance with the present invention.

In at least one embodiment, the netting will have a strength-to-weight ratio of 0.5 to 20 lb_{f}/(in.×PMSF), in other embodiments 2 to 10 lb_{f}/(in.×PMSF).

In at least one embodiment, the netting has a basis weight of between 0.3 to 1000 lbs./1000 square feet, in other embodiments between 1 to 100 lbs./1000 square feet, and in yet other embodiments 10 to 50 lbs./1000 square feet, as measured in accordance with ASTM D3776.

In at least one embodiment, the netting has a machine direction tensile to break strength of 0.1 to 100 lbs./strand, in other embodiments between 1 to 25 lbs./strand, and in yet other embodiments 2 to 15 lbs./strand, as measured in accordance with either of the netting tensile strength tests.

In at least one embodiment, the netting has a cross direction tensile to break strength of 0.1 to 100 lbs./strand, in other embodiments between 1 to 25 lbs./strand, and in yet other embodiments 2 to 15 lbs./strand, as measured in accordance with either of the netting tensile strength tests.

In at least one embodiment, the netting has a machine direction strands per inch (i.e., strand count) of 0.1 to 50 strands/inch, in other embodiments 0.5 to 25 strands per inch, and in yet other embodiments 1 to 10 strands/inch. The strand count is taken while the netting is laying flat and not under tension of compression.

In at least one embodiment, the netting has a cross direction strands per inch of 0.1 to 50 strands/inch, in other embodiments 0.5 to 25 strands/inch, and in yet other embodiments 1 to 6 strands per inch.

In some embodiments, the netting has strands that have an average thickness (i.e., diameter) of 1 to 300 mils, in other embodiments 10 to 50 mils, and in yet other embodiments 15 to 40 mils, as measured in accordance with ASTM 1777-64, using a one inch diameter swivel foot, with a 120 g mass, measured to the closest mil.

The netting made in accordance with the present invention has many potential uses. Particularly, the properties of the netting make the netting of the invention particularly suitable for use as turf net, turf wrap, hay bale wrap, and erosion control applications. Particularly, the netting may be used to hold blankets of straw, excelsior, coconut and other adsorbent fibers together while brush is allowed to grow and prevents runoff during the early stage of growth. The netting can also be used for packaging, such as to wrap pallets and agriculture.

The netting can also be used to form other types of composites wherein the netting is secured to at least one or more layers of material. Examples of such composites include consumer wipes, reinforced tissue towels, and erosion control composites.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A degradable netting comprising a plurality of interconnected strands, at least some of the strands being made of a degradable composition consisting essentially of a polyolefin and an oxo-biodegradable additive.

2. The degradable netting of claim 1 wherein the oxo-biodegradable additive comprises a metal carboxylate.

3. The degradable netting of claim 1 wherein the degradable composition consists essentially of a polyolefin, a metal carboxylate, and a stabilizer.

4. The degradable netting of claim 3 wherein the degradable composition further consists essentially of a colorant and a photo-degradable additive.

5. The degradable netting of claim 1 wherein the polyolefin is present in the degradable composition in an amount of 95 to 99.95 wt. % and the oxo-biodegradable additive is present in the degradable composition in an amount of 0.05 to 5 wt. %, based on the total weight of the degradable composition.

6. The degradable netting of claim 5 wherein the oxo-biodegradable additive comprises a metal carboxylate.

7. The degradable netting of claim 2 wherein the degradable composition consists essentially of 89 to 99.93 wt. % of a polyolefin, 0.05 to 5 wt. % of a metal carboxylate, 0.01 to 2 wt. % of a stabilizer, and 0.01 to 4 wt. % of a colorant, based on the total weight of the degradable composition.

8. The degradable netting of claim 2 wherein the degradable composition consists essentially of 84 to 99.83 wt. % of a polyolefin, 0.05 to 5 wt. % of a metal carboxylate, 0.01 to 2 wt. % of a stabilizer, 0.01 to 4 wt. % of a colorant, 0.1 to 5 wt. % of photo-degradable additives, and 0.1 to 5 wt. % biodegradable promoter based on the total weight of the degradable composition.

9. A method of making a degradable netting, said method comprising interconnecting a plurality of strands wherein at least some of the strands comprise a degradable composition consisting essentially of a polyolefin and an oxo-biodegradable additive

10. The method of claim 9 wherein the oxo-biodegradable additive comprises metal carboxylate.

11. The method of claim 9 wherein the step of interconnecting comprises extruding a first set of stands in a first direction and extruding a second set of strands in a second direction so that the second set of strands intersect the first set of strands.

12. The method of claim 9 wherein the step of interconnecting comprises knitting the strands together to form a knitted netting.

13. A composite comprising:
the netting of claim 1, the netting having a first side and a second side, opposite the first side; and
a first layer of material secured to the first side of the netting.

14. The netting of claim 1 wherein the netting comprises an erosion control netting.

15. The netting of claim 1 wherein the netting comprises a hay bale wrap netting or a netting for use with turf.

16. The netting of claim 1 wherein the netting comprises netting for use with food packaging.

17. The netting of claim 8 wherein the colorant is titanium dioxide or carbon black.

18. The degradable netting of claim 1 wherein the netting does not have citric acid or any aliphatic polyhydroxycarboxyl acid.

19. The degradable netting of claim 1 wherein the netting can degrade either in the presence or absence of UV light.

20. A degradable netting comprising a plurality of interconnected strands, at least some of the strands being made of a degradable composition consisting essentially of 84 to 99.83 wt. % of a polyolefin, 0.05 to 5 wt. % of a metal carboxylate, 0.01 to 2 wt. % of a stabilizer, 0.01 to 4 wt. % of a colorant, 0.1 to 5 wt. % of photo-sensitive polymer, and 0.1 to 5 wt. % micronized cellulose, based on the total weight of the degradable composition.
